(19) United States
(12) Patent Application Publication
(10) Pub. No.: US 2021/0179785 A1
(43) Pub. Date: Jun. 17, 2021

(54) METHOD FOR PRODUCING SPHERICAL POLYSILSESQUIOXANE PARTICLES

(71) Applicant: WACKER CHEMIE AG, Munich (DE)

(72) Inventors: Sebastian KNOER, Emmerting (DE); Kathrin SEILINGER, Burghausen (DE)

(73) Assignee: WACKER CHEMIE AG, Munich (DE)

(21) Appl. No.: 16/758,945

(22) PCT Filed: Oct. 30, 2017
(86) PCT No.: PCT/EP2017/077732

§ 371 Date: Apr. 24, 2020

(51) Int. Cl. C08G 77/10; C08G 77/18

(52) U.S. Cl. CPC C08G 77/10; C08G 77/18

(57) ABSTRACT

Spherical polysilsesquioxane particles in which, in a first step, trialkoxysilane of formula (I)

RSi(OR¹)₃ (I),

in which
R represents a C₁₋₁₆ hydrocarbon radical whose carbon chain may be interrupted by nonadjacent —O— groups, and
R^{l} represents a C₁₋₄ alkyl radical,
   is reacted with acidified water having a pH of not more than 6 with commixing to afford a hydrolyzate,
   in a second step the hydrolyzate is mixed with a solution of a base in water or C₁₋₄ alkanol,
   in a third step the mixture is stored for 30 minutes to 6 hours,
   in a fourth step the mixture is mixed with a further solution of a base in water or C₁₋₄ alkanol,
   in a fifth step the mixture is agitated for at least 5 minutes,
   and in a sixth step the polysilsesquioxane particles are isolated.

### CROSS REFERENCE TO RELATED APPLICATIONS

This application is the U.S. National Phase of PCT PCT/EP2017/077732 filed Oct. 30, 2017 the disclosure of which is incorporated in its entirety by reference herein.

### BACKGROUND OF THE INVENTION

### 1. Field of the Invention

The invention relates to a process for producing polysilsesuioxane particles by hydrolyzis of trialkoxysilane and condensation of the hydrolyzate with base.

### 2. Description of the Related Art

The prior art, in particular. JP397044B2, JPH0488023 and JPH06248081A, discloses various processes for generating spherical polymethylsilsesquioxane particles and is concerned with optimizing space-time yield or controlling particle size. No process has hitherto been described which allows control of the agglomerization behavior of the particles. Pulverulent products are obtained in complex fashion by drying and subsequent milling. Crushing or milling using a jet mill is necessary for deagglomeration of the particles that have undergone sintering in the conventional drying.

### SUMMARY OF THE INVENTION

The present invention provides a process for producing spherical polysilsesquioxane particles in which in a first step trialkoxysilane of general formula (I)

RSi(OR¹)₃ (I),

in which
R represents a hydrocarbon radical having 1 to 16 carbon atoms whose carbon chain may be interrupted by nonadjacent —O— groups,
represents a C₁- to C₄-alkyl radical,
   is reacted with acidified water having a pH of not more than 6 with commixing to afford a hydrolyzate,
in a second step the hydrolyzate is mixed with a solution of a base in water or C₁- to C₄-alkanol,
in a third step the mixture is stored for 30 minutes to 6 hours,
in a fourth step the mixture is mixed with a further solution of a base in water or C₁- to C₄-alkanol,
in a fifth step the mixture is stored or agitated for at least 5 minutes
and in a sixth step the polysilsesquioxane particles are isolated.

### DETAILED DESCRIPTION OF THE PREFERRED EMBODIMENTS

It has been found that the sintering of the polysilsesquioxane particles during drying can be avoided when at least 5 min before isolation of the particles an additional portion of base is added to the mother liquor. This makes it possible to obtain fine powders without additional milling.

The invention provides an improved process for generating agglomeration-free, spherical polymethylsilsesquioxane particles. The process according to the invention allows for the production of spherical polymethylsilsesquioxane particles in a very short process time and thus avoids sintering of the particles. A complex milling of the particles as described in the prior art may thus be avoided.

For use in cosmetic products and in industrial applications, for example as antiblocking agents, it is important and quality-relevant that the polymethylsilsesquioxane particles are fine-grained and do not form a strong interaction with one another, in order that they may be easily spread. Larger grains, through solid agglomerates or sintered particles, in cosmetic products have a poor sensory feel and can even scratch and in topcoats result in surface defects.

For precipitation times of less than 5 h without additional base addition in the fourth step a grainy product is obtained. The grains are comparatively hard, which points to a strong cohesion of the individual particles. Fine powders can be obtained only by additional milling. The hardness of the grains and the interaction of the particles decreases with increasing precipitation time. Only at precipitation times >5 h are soft powders obtained. However, long precipitation times result in high production costs.

The dried particles produced by the process according to the invention exhibit no relevant interaction with one another even after a total precipitation time of 1.5 h (steps 2 to 5). Depending on the base used, in some cases fine, powdery products are obtained directly. Crumbly products decompose into fine powders by mere shaking, stirring or upon sieving. The hardness of the crumbs and the interaction of the particles decreases with increasing precipitation time.

R preferably represents an alkyl radical having 1 to 6 carbon atoms or a phenyl radical, in particular an ethyl radical or a methyl radical.

R¹ preferably represents a methyl, ethyl or n-propyl radical, in particular a methyl radical.

Preferred trialkoxysilanes of general formula (I) are methyltrimethoxysilane, methyltriethoxysilane, methyltri-n-propoxysilane, methyltriisopropoxysilane and methyltris(2-methoxyethoxy)silane and mixtures thereof.

The reaction to afford a hydrolyzate is preferably effected in acidified water having a pH of not more than 5.5, more preferably not more than 4.5 and preferably at least 1, more preferably at least 2, and in particular at least 2.3.

The water employed is preferably demineralized and before acidification preferably has a conductivity of not more than 50 μS/cm, more preferably not more than 30 μS/cm, yet more preferably not more than 20 μS/cm, and most preferably not more than 10 μS/cm, in each case measured at 20° C.

The water employed may be acidified using Brønsted acids or Lewis acids.

Examples of Lewis acids are BF₃, AlCl₃, TiCl₃, SnCl₄, SO₃, PCl₅, POCl₃, FeCl₃ and hydrates thereof, and ZnCl₂. Examples of Brønsted acids are hydrochloric acid, hydrobromic acid, sulfuric acid, nitric acid, nitrous acid, chlorosulfonic acid, phosphoric acids such as ortho-, meta- and polyphosphoric acids, boric acid, selenous acid, nitric acid, carboxylic acids such as formic acid, acetic acid, propionic acid, citric acid and oxalic acid, haloacetic acids such as trichloroacetic and trifluoroacetic acid, p-toluene sulfonic acid, acidic ion exchangers, acidic zeolites and acid-activated Fuller's earth.

Hydrochloric acid, hydrobromic acid and acetic acid are preferred.

The acidification of the water may be effected before the conversion to the hydrolyzate, simultaneously with the conversion or both before the conversion and simultaneously with the conversion.

Hydrolyzis of the trialkoxysilane of general formula (I) is a weakly exothermic reaction. In a preferred embodiment the temperature in the first step is maintained optionally by heating or cooling by preference at 0° C. to 60° C., more preferably at 10° C. to 50° C., yet more preferably at 15° C. to 40° C., still more preferably at 15° C. to 30° C., and in particular at 15-25° C., wherein the temperature variation after attainment pf the target temperature is by preference less than 10° C., more preferably less than 5° C. The metered addition of the trialkoxysilane may be commenced before or after attainment of the target temperature, as desired.

In another embodiment the trialkoxysilane is metered in in one portion. The heat is not actively or only partly removed by cooling. In this embodiment an exothermic increase in temperature takes place after addition of the trialkoxysilane. The temperature of the reaction in the first step is 20° C. to 80° C., preferably up to 60° C.

It is preferable that the trialkoxysilane is metered in over 0.5 to 5 h, more preferably not more than 2 h. Between rapid addition and metered addition there is a fluid transition of inventive embodiments, i.e. it is possible for example to effect addition rapidly in 15 min with partial removal of heat up to not more than 40° C. or it is possible to effect metered addition over 2 h but only perform a low level of cooling thus initially allowing a temperature increase to 30° C. and maintaining at this temperature.

Metered addition at a constant temperature is particularly preferred.

It is preferable when in the first step 5 to 43 parts by weight, preferably 11 to 34 parts by weight, and in particular 13 to 25 parts by weight of trialkoxysilane are added per 100 parts by weight of water.

It is preferable when after metered addition of the trialkoxysilane the mixture is subjected to further stirring for 5 min to 5 h, more preferably 10 min to 3 h, and in particular 15 min to 1.5 h. The further stirring time is preferably chosen such that the sum of the addition time for the silane and the further stirring time do not exceed 6 h.

The temperature during the further stirring is maintained at 0° C. to 60° C., preferably at 10° C. to 50° C., more preferably at 10° C. to 40° C., yet more preferably at 10° C. to 30° C., and in particular at 15° C. to 25° C. It is preferable when the difference in the temperature of the reaction in the first step and the temperature during the further stirring is less than 20° C., more preferably less than 10° C., and in particular less than 5° C.

Kinetics studies using NMR have shown that the rate of hydrolyzis of the trialkoxysilanes of general formula (I) in an acidic environment is pH-dependent and proceeds faster the lower the pH. The rate of the condensation reaction is likewise pH-dependent and increases at low pH. In a preferred embodiment the pH of the hydrolyzate may be adjusted to 1 to 6 after the first step before the hydrolyzate is precipitated with a defined amount of base in the second step.

The target pH in the acidic range may in principle be freely defined. The target pH is preferably at least 2, more preferably at least 2.3 and preferably not more than 5.5, more preferably not more than 4.5.

The more precisely the target pH is adjusted the narrower the distribution of the average particle size between different reaction batches. The deviation of the pH is preferably less than ±1, more preferably less than ±0.5, and most preferably less than ±0.3, in particular less than ±0.1.

It is preferable when the pH of the hydrolyzate is adjusted using an acid which may also be employed in the first step or using a base which may also be employed in the second step.

It is preferable when in the second step the base is selected from alkali metal hydroxides, alkaline earth metal hydroxides, alkali metal methoxides, ammonia and organic amines. Preferred organic amines are alkylamines such as mono-, di-, or triethyiamine, mono-, di-, or trimethylamine, or 1,2-ethylenediamine. It is preferable to employ the hydroxides of Li, Na, K. It is preferable to employ a solution of alkali metal hydroxide in water or in an alkanol having 1 to 3 carbon atoms. Preferred alkanols are 1-propanol, 2-propanol, ethanol and in particular methanol. A solution of ammonia or alkali metal hydroxide in water is likewise preferred. Dilute or concentrated solutions of alkali metal hydroxide of 0.001 to 1100 g/l at 20° C., preferably 0.01 to 500 g/l, more preferably 0.1 to 500 g/l, are suitable.

When using a solution of alkali metal hydroxide in an alkanol having 1 to 3 carbon atoms in the second step the particles adhere to one another to a particularly small extent, show a particularly low degree of agglomeration and have less of a propensity for clumping. The particles show a preferred drier skin feel in cosmetic applications.

KOH is preferred as the alkali metal hydroxide.

Also possible as an alternative to NaOH and KOH is the use of an NaOH— or KOH-former which in the second step immediately reacts with the water present in the hydrolyzate to afford NaOH or KOH. Examples thereof are sodium ethoxide, potassium methoxide, NaH and KH. In this embodiment the use of sodium ethoxide or potassium methoxide in methanolic solution is preferred.

In a preferred embodiment the temperature during the addition of the solution of a base in the second step is maintained by preference at 0° C. to 60° C., more preferably at 10° C. to 50° C., yet more preferably 10° C. to 40° C., stll more preferably at 10° C. to 30° C., and in particular at 15° C. to 25° C. It is preferable when the difference in the temperature during further stirring and the temperature during addition of the solution of a base is less than 20° C., more preferably less than 10° C. and in particular less than 5° C. In particular, the second step is performed at the temperature exhibited by the hydrolyzate after the first step.

It is preferable when, in the second step, sufficient solution of base is added to ensure that a pH of at least 6, preferably at least 6.5, and not more than 10, preferably not more than 9.5, is achieved, in each case measured immediately after addition of the base. Particle size may be influenced by the addition of the amount of base, wherein lower pHs result in larger particles. The especially preferred pH is 7.5 to 9.

The solution of base is preferably added in the second step over 10 seconds to 10 minutes, in particular over 1 to 5 minutes, preferably with vigorous and short stirring.

A clouding is usually visible in the third step even after 1-30 minutes.

In the third step the mixture is not agitated. If in the starting phase in the third step, in which the formation of the particles is effected, the mixture is agitated this results in an increased incidence of malformed, coalesced or agglomerated particles.

It is preferable when, in the third step, the mixture is stored for 45 min to 6 h, more preferably 1 h to 5 h, and in particular not more than 4 h.

The temperature in the third step is by preference 0° C. to 60° C., more preferably 10° C. to 50° C., yet more preferably 10° C. to 40° C., still more preferably 10° C. to 30° C., in particular 15° C. to 25° C. Low temperatures result in formation of larger particles and higher temperatures result in formation of smaller particles.

At a temperature of 15° C. to 25° C., there is little if any temperature gradient in the reaction mixture toward the outer region, thus a minimal thermal gradient between the reactor wall and the reaction solution, and thus minimized thermal convection during the precipitation of the particles in the third step.

In the third step the temperature of the mixture is altered by not more than 20° C., preferably not more than 10° C., by preference for at least 1h, preferably at least 1.5 h, and more preferably at least 2.5 h.

It is preferable when in the fourth step the same base is employed as in the second step.

In a preferred embodiment, the temperature during the addition of the solution of a base in the fourth step is maintained by preference at 0° C. to 60° C., more preferably at 10° C. to 50° C., yet more preferably 10° C. to 40° C., still more preferably at 10° C. to 30° C., and in particular at 15° C. to 25° C. It is preferable when the difference in the temperature in the third step and the temperature during the addition of the solution of a base in the fourth step is less than 20° C., more preferably less than 10° C., and in particular less than 5° C. In particular, the fourth step is performed at the temperature exhibited by the mixture after the third step.

The solution of base in the fourth step is preferably added over 10 seconds to 10 minutes, and in particular over 30 seconds to 5 minutes, preferably with vigorous and short stirring.

In a preferred embodiment the mixture after the fifth step is neutralized by addition of an acid, preferably with the same acid as used for acidifying the water in the first step.

The commixing in the first, second, fourth and fifth step may, independently in each case, be effected by means of a static mixer or preferably by means of a stirrer.

In the fifth step, the mixture is stored or stirred, preferably stirred, in particular at low speed, for preferably 10 min to 2 h, more preferably 15 min to 1.5 h, and in particular 30 min to 1 h.

It is preferable when the temperature and the temperature gradient in the fifth step have the same values as in the third step.

In the sixth step the particles are isolated, preferably by filtration or centrifugation.

After isolation the particles are preferably washed with demineralized (DM) water or alcohol and preferably dried.

Drying is preferably effected at 40° C. to 250° C., more preferably at 100° C. to 240° C., and most preferably at 140° C. to 220° C. Drying may be effected at atmospheric pressure or at reduced pressure. During drying, a condensation of free Si—OH groups also takes place which according to kinetics measurements takes place preferably above 150° C., more preferably above 180° C., and ideally above 200° C. While particles which have been dried at 100° C. for a long time are dry, they do have a high Si—OH content. At 150° C. the Si—OH content is markedly reduced but not yet fully removed, and at 200° C. Si—OH groups are again significantly reduced. A reduced Si—OH content results in advantages in the spreading behavior and in the fluidization of the particles. In specific applications, for example of aqueous dispersions of the particles, Si—OH-rich and thus comparatively hydrophilic particles may be advantageous. These may be generated by selection of a lowest possible drying temperature.

The polysilsesquioxane particles are preferably dried for 0.5 to 100 h, more preferably 0.5 to 24 h, and in particular 1 to 14 h.

It is preferable when the polysilsesquioxane particles are agitated during drying, for example by means of a fluidized bed dryer or paddle dryer.

A milling of the particles is not necessary. The inventive particles exhibit a very advantageous behavior, in particular for cosmetic applications. They exhibit only a weak interaction with one another and, even at low shear, are exceptionally easily and uniformly spreadable, and bring about a velvety skin feel. This behavior is not observable in the case of strongly agglomerated or coalesced particles. These undergo balling during spreading on the skin, show a nonuniform distribution on the skin and feel comparatively chalky, dull or even scratchy.

The dried and unmilled polysilsesquioxane particles produced by the process according to the invention comprise by preference less than 35% by weight, more preferably less than 30% by weight, and more preferably less than 20% by weight of a sieve fraction >200 μm.

The process according to the invention may be run as a batch process, as a semi-batch process, or as a continuous process.

A particularly high freedom from agglomeration of the polysilsesquioxane particles may be achieved by a subsequent milling.

In a particular embodiment a dry, free-flowing powder may be produced in a spray dryer from the mixture obtained after the fifth step or from the dispersion obtained by isolating, washing and redispersing the mixture obtained from the fifth step. Depending on the alcohol content of the mixture the drying gas employed is air or inert gas, for example nitrogen, argon, helium, lean air comprising not more than 2% oxygen. The spray drying may be performed in any desired apparatuses that are suitable for the spray drying of liquids and are already well known.

In a particular embodiment the spray-dried polysilsesquioxane particles are subjected to post-drying, for example in a paddle dryer, fluidized bed dryer, tray dryer, jet dryer or drum dryer.

The polysilsesquioxane particles preferably exhibit a spherical shape upon examination in an electron microscope. The spherical polysilsesquioxane particles preferably exhibit an average sphericity y of at least 0.6, in particular at least 0.7. The spherical polysilsesquioxane particles preferably have an average roundness x of at least 0.6, in particular at least 0.7. The roundness x and sphericity y may be determined according to DIN EN ISO 13503-2, page 37, annex B.3, in particular figure B.1.

It is preferable when all process steps are performed at the pressure of the ambient atmosphere, i.e. about 0.1 MPa (abs.); they may also be performed at higher or lower pressures. Preferred are pressures of at least 0.08 MPa (abs.) and more preferably at least 0.09 MPa (abs.), and preferably not more than 0.2 MPa (abs.), in particular not more than 0.15 MPa (abs.).

All of the abovementioned symbols of the abovementioned formulae are defined each independently of one another. The silicon atom is tetravalent in all formulae. In the examples which follow, unless otherwise stated in each case, all amounts and percentages are based on weight, all pressures are 0.10 MPa (abs.) and all temperatures are 20° C.

### Sieve Analysis:

Sieve analysis was by means of dry sieving using an analytical Retsch AS 200 basic sieve machine at 100% amplitude. For analysis four sieves according to DIN ISO 3310 having the following mesh sizes were stacked: 200 μm, 100 μm, 40 μm, 20 μm, tray. In each case 100 g of substance was applied atop the first sieve (200 μm) and sieved for 10 minutes. The residues in the individual sieves and the tray were then weighed.

### EXAMPLES

### General Procedure: Production of Polymethylsilsesquioxane Particles

32 kg of demineralized (DM) water having a conductivity of 0.1 μS/cm are initially charged into an enameled 50 liter stirred tank with jacket cooling, and temperature-controlled to 20° C. The mixture is stirred at 150 rpm. The pH is adjusted to pH 4.40 by addition of 0.1 molar hydrochloric acid. 7.0 kg of methyltrimethoxysilane are added over 1 h while the temperature is held at 20° C. Once addition has ended, the mixture is stirred for 30 minutes at 20° C.

The pH is optionally corrected.

Once the correction has ended, the mixture is stirred for a further 30 minutes at 20° C. The first base addition is effected over 1 min at 20° C. The mixture is mixed to homogeneity for 3 min. The stirrer is then switched off and the solution is left to rest for precipitation (resting time step 3 see table 1). The stirrer is subsequently switched on at a low level for 3 min to stir up any sediment. The optional second base addition is effected over 1 min at 20° C. The mixture is subsequently stirred at a low level for 30 min. After termination of the precipitation the particles are filtered off, washed with DM water and dried at 15° C for 8 h.

The following table 1 summarizes the present data. It is apparent that only the process according to the invention affords soft particles having little coarse fraction (>200 μm) coupled with a short precipitation time, (second to fifth step). The term “soft” is to be understood as meaning that the product is in the form of a powder or any grains present can be crushed to afford a powder without appreciable force application.

In the noninventive comparative examples C5, C10 and C11, soft particles are obtained only after an unacceptably long precipitation time.

TABLE 1

| | | Resting | Second | | | |
|---|---|---|---|---|---|---|
| | | time | addition | Constitution after | | Sieve fraction |
| Example | Base used | (step 3) | (step 4) | static drying | Feel | >200 μm (%) |
| C1 | KOH | 1 h | no | grainy | hard | |
| C2 | KOH | 1.5 h | no | grainy | hard | |
| C3 | KOH | 2.5 h | no | fine-grained | hard | 36 |
| C4 | KOH | 4.5 h | no | grainy | medium-hard | 45 |
| C5 | KOH | 22.5 h | no | powdery | soft | 5 |
| 1 | KOH | 1.5 h | yes | fine-grained | soft | |
| 2 | KOH | 2.5 h | yes | powdery | sott | 14 |
| 3 | KOH | 4.5 h | yes | Powdery | soft | 10 |
| C5 | KOH | 22.5 h | yes | Powdery | soft | 5 |
| C6 | NH₃ | 1 h | no | grainy | hard | 97 |
| C7 | NH₃ | 1.5 h | no | grainy | hard | 64 |
| C7 | NH₃ | 2.5 h | no | grainy | medium-hard | |
| C9 | NH₃ | 4.5 h | no | grainy | medium-hard | |
| C10 | NH₃ | 22.5 h | no | powdery | soft | 9 |
| 4 | NH₃ | 1 h | yes | powdery | soft | 13 |
| 5 | NH₃ | 1.5 h | yes | powdery | soft | 11 |
| 6 | NH₃ | 2.5 h | yes | powdery | soft | |
| 7 | NH₃ | 4.5 h | yes | powdery | soft | |
| C11 | NH₃ | 22.5 h | yes | powdery | soft | 8 |

1.-11. (canceled)

12. A process for producing spherical polysilsesquioxane particles, comprising:
in a first step, reacting at least one trialkoxysilane of formula (I)
RSi(OR¹)₃ (I),
in which
represents a hydrocarbon radical having 1 to 16 carbon atoms whose carbon chain is optionally interrupted by nonadjacent —O-groups, and
R1 represents a C₁- to C₄-alkyl radical,
with acidified water having a pH of not more than 6 with commixing to afford a hydrolysate;
in a second step, mixing the hydrolyzate with a solution of a base in water and/or C₁- to C₄-alkanol;
in a third step storing the mixture for 30 minutes to 6 hours;
in a fourth step, mixing the mixture with a further solution of a base in water and/or C₁- to C₄-alkanol;
in a fifth step, storing or agitating the mixture for at least 5 minutes;
and in a sixth step, isolating the polysilsesquioxane particles.

13. The process of claim 12, in which R represents an ethyl radical or a methyl radical.

14. The process of claim 12, in which R¹ represents an ethyl radical or a methyl radical.

15. The process of claim 13, in which R¹ represents an ethyl radical or a methyl radical.

16. The process of claim 12, in which in the first step the reaction to afford the hydrolyzate is effected at a pH of 4.5 to 2.

17. The process of claim 13, in which in the first step the reaction to afford the hydrolyzate is effected at a pH of 4.5 to 2.

18. The process of claim 14, in which in the first step the reaction to afford the hydrolyzate is effected at a pH of 4.5 to 2.

19. The process of claim 12, in which in the second step a solution of alkali metal hydroxide in water and/or an alkanol having 1 to 3 carbon atoms is employed.

20. The process of claim 13, in which in the second step a solution of alkali metal hydroxide in water and/or an alkanol having 1 to 3 carbon atoms is employed.

21. The process of claim 14, in which in the second step a solution of alkali metal hydroxide in water and/or an alkanol having 1 to 3 carbon atoms is employed.

22. The process of claim 12, in which in the second step sufficient solution of base is added to ensure that a pH of 6.5 to 9.5 is achieved, in each case measured immediately after addition of base.

23. The process of claim 12, in which in the third step the temperature of the mixture is altered by not more than 10° C. for at least 1 h.

24. The process of claim 12, in which in the fourth step the same base is employed as in the second step.

25. The process of claim 12, in which after the fourth step the mixture is neutralized by addition of an acid.

26. The process of claim 12, in which the mixture is stirred in the fifth step.

27. The process of claim 12, in which the particles are isolated by filtration or centrifugation in the sixth step.
